(19) United States
(12) Patent Application Publication
(10) Pub. No.: US 2012/0018355 A1
(43) Pub. Date: Jan. 26, 2012

(54) Method of separating material in a vibratory device

(76) Inventors: Grant Young, Tulsa, OK (US); Ray Young, Glenpool, OK (US); Donald L. Dunning, Chapin, SC (US)

(21) Appl. No.: 12/804,546

(22) Filed: Jul. 24, 2010

(51) Int. Cl. B07B 1/28

(52) U.S. Cl. 209/311

(57) ABSTRACT

A process of separating a fluid and fibrous material from wet fibrous matter can include:

1) Putting the wet fibrous matter onto a vibrating screen device which has a plurality of screens in a sequential configuration. Each screen has a perforated center portion with elliptically shaped perforations with a span of no greater than 0.1 inches.
2) Vibrating each screen to expedite separation of the fibrous material and the fluid from the wet fibrous matter on each screen such that the fluid separated from the wet fibrous matter on each screen passes through the perforations and the fibrous material conveys along the screen.
3) Conveying the fibrous material from a screen that is sequentially before to a screen that is sequentially after for further separating the fluid from the fibrous material.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to shakers for separating solids from a fluid.

### BACKGROUND OF THE INVENTION

Shakers or other vibrating screen devices can be used to separate solids from fluids. Some shakers have multiple screens with a porous material for separating the solids from the fluid. The fluid passes through the porous material and the solids remain atop the screen to be conveyed off. The screens can have a stepped arrangement. Solids fall from the discharge end of each screen to the feed end of the next screen. With particularly fibrous or elongated strands of solid material, conveyance along the screens can be hindered by the fibrous material being caught in the screen resulting in a pileup of solids and blinding of the screen surface. As used in this application, “blinding” refers to the condition when a screen has lost much of its filtering capability due to the pores within the screen being plugged to the point of substantially interfering with fluid flow through the screen. With fibrous material, the separation process must often be temporarily stopped to clean the screen. In addition these snags can eventually shorten the life of the screen due to screen blinding. There is a need for a process to separate fluid from fibrous material that provides consistent and effective conveyance of the solid fibrous material during the separation and for a screen that can be used to improve this process.

The instant invention, with its multiple embodiments as disclosed within this application, provides a process and a screen that fills this need. The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, a process of separating a fluid and fibrous material from wet fibrous matter can be done by:

1) putting the wet fibrous matter onto a screen in a vibrating screen device where the screen has a porous center portion and pores of no greater than 0.1 inches,
2) vibrating the screen to improve separation of the fibrous material and the fluid from the wet fibrous matter such that the fluid passes through the pores and the fibrous material conveys along the screen.

In at least one embodiment of the invention, the pores are perforations. In some embodiments the perforations have a span of no greater than 1/32 inches. In at least one embodiment of the invention, the fibrous matter is selected from the group consisting of biological matter, petroleum based matter, geologic matter, and any combination thereof. In at least one embodiment of the invention, the screen is constructed of a metal, a plastic, a ceramic, or any combination of these.

In at least one embodiment of the invention, the screen is coated with a coating material and the perforations are formed through the coating material. In at least one embodiment of the invention, the coating is a paint, plastic, epoxy, or any combination thereof.

In at least one embodiment of the invention multiple screens are used with the screens being sequentially arranged. As used in this application screens that are “sequential” or that have a “sequential configuration” convey material from one screen to the next screen in the sequence and/or allow material (solid or fluid) to pass through the pores/perforations of one screen and/or over the edges of one screen to the next screen in sequence. So, a sequential configuration includes but is not limited to 1) screens positioned one above another, 2) screens adjacent one another without a substantial step down between them such that material conveys from one screen to the next (screens can actually butt up against one another), and 3) screens configured in a stepped down configuration such that the conveyed material from one screen falls off the edge of the one screen onto the next screen in the sequence.

Also, a screen that is “sequentially after” is a screen in the sequence that receives material (solid or fluid) from another screen in the sequence. A screen that is “sequentially before” is a screen in the sequence that transfers material (solid or fluid) to another screen in the sequence. Obviously if there are more than two screens in the sequential configuration at least one will be both “sequentially after” another screen and “sequentially before” another screen.

In at least one embodiment of the invention the perforated plates are sprayed from below or above to help clear solid material that may be stuck on or in the pores/perforations of the screen.

In at least one embodiment of the invention, the fluid is a water based fluid, an oil based fluid, a gelatinous based fluid, a plasma based fluid, or any combination thereof.

In at least one embodiment of the invention, the fibrous matter is biological matter, petroleum based matter, geologic matter, or any combination thereof.

The patent application titled “Vibrating Screen Device” and having patent application Ser. No. 12/658,686 is incorporated by reference. The vibratory screen device of this previously filed patent application can be used in many embodiments disclosed herein.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of a portion of wire square mesh that can be used in a separating screen

FIG. 2 is a perspective view of a portion of wire square mesh that has fibrous material caught in the wires.

FIG. 2a is an enlarged top view of a portion of wire square mesh that has fibrous material caught in the wires.

FIG. 3 is a perspective view of a portion of a perforated screen having oval perforations.

FIG. 3a is a perspective view of a portion of a perforated screen illustrating the span of a perforation.

FIG. 4 is a schematic perspective view of two screens with the upper screen having larger sized pores than the lower screen.

FIG. 5 is a schematic perspective view of three screens with the uppermost screen having larger sized pores than the two lower screens.

FIG. 6a is a schematic side view of a wire screen

FIG. 6b is a schematic side view of a wire screen having a coating.

FIG. 7 is a perspective view of a shaker having screens in a stepped down configuration.

FIGS. 8a and 8b are cross-section side views of perforated plates.

FIG. 9 is a perspective view of a non-flat perforated plate.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. Unless otherwise stated, the term “oval” includes an oval, ellipse, circle, or any other shape without corners. Additionally, within this application the term “proximal” end of the shaker or screen is the end in which the material to be separated is introduced; the “distal” end of the shaker or screen is the end toward which the separated solids are conveyed. For purposes of this application, the term “perforation” refers to a hole formed by removing material from a sheet or plate or moving material on the plate to form a hole; a “perforated plate” is a sheet or plate having holes formed by removal of material from the sheet or plate or by moving material on the sheet of plate. Though there can be other methods of creating these perforations some methods include by punching holes out with a press or with fluid or gas pressure; grinding holes; cutting holes through by use of a saw, laser, liquid, or gas; chemically creating the holes, or any combination of these. As used in this application, fibrous material is material that has a length that is at least three times as long as any of the other dimensions of the material. Finally, as used in this application when describing or stating that fibrous material and fluid are separated from wet fibrous matter, the fibrous material can still have fluid mixed with it, however it has less than the original wet fibrous matter.

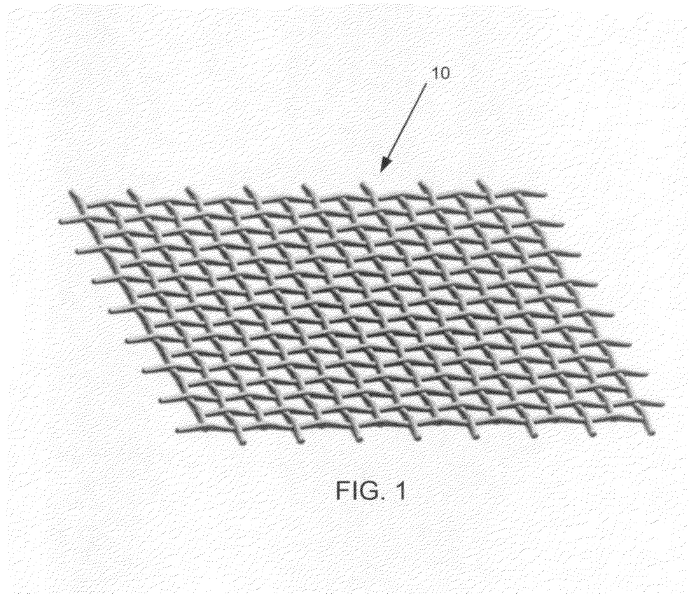

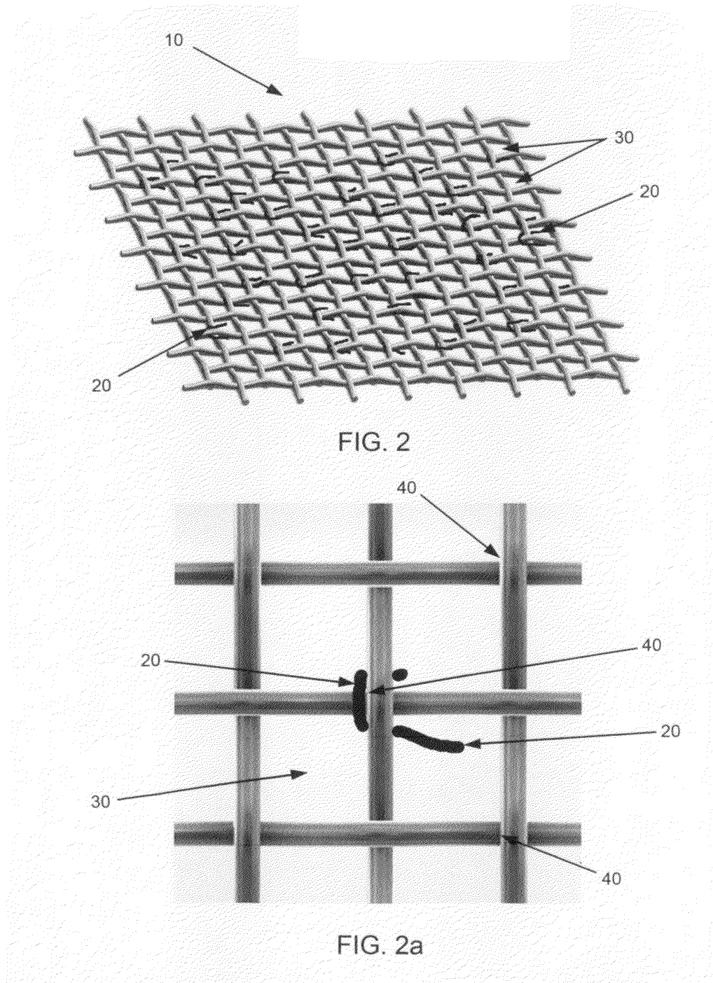

In FIG. 1 a Prior Art portion of woven wire square mesh screening 10 is shown. The term woven here is used to describe the product rather than the method of construction even if the actual method for constructing the screen 10 is weaving. There are many weaves, all woven screens consist of one form or another of over under wiring. This material has been used in separating solids from fluids in wetted material. When the material to have the fluid and solid matter is fibrous, blinding of the screening or screen 10 with this fibrous material can occur. As shown in FIG. 2 fibers 20 from the fibrous material to be processed can get caught in the pore openings 30. As shown in the magnified view of FIG. 2a, these fibers 20 tend to get caught in corners 40 of pores 30 or where wires cross.

These screens 10 when used with fibrous materials such as toilet paper in the sewer industry, cow manure in the dairy industry and slaughter houses, and in processing waste meat and feathers in the chicken processing industry typically have fibrous materials get caught in these corners 40. This can begin the screen blinding process where then more and more material hang up in the screen 10 because it can now hang on the fibers that are already caught first at the screen corners 40 and then on those caught fibers 20 themselves. As this continues, the screen opening 30 can become plugged/blinded. Cleaning a screen 10 which was blinded with fibrous material can often require scrubbing with a brush which can be labor intensive and may shorten the life of a screen 10.

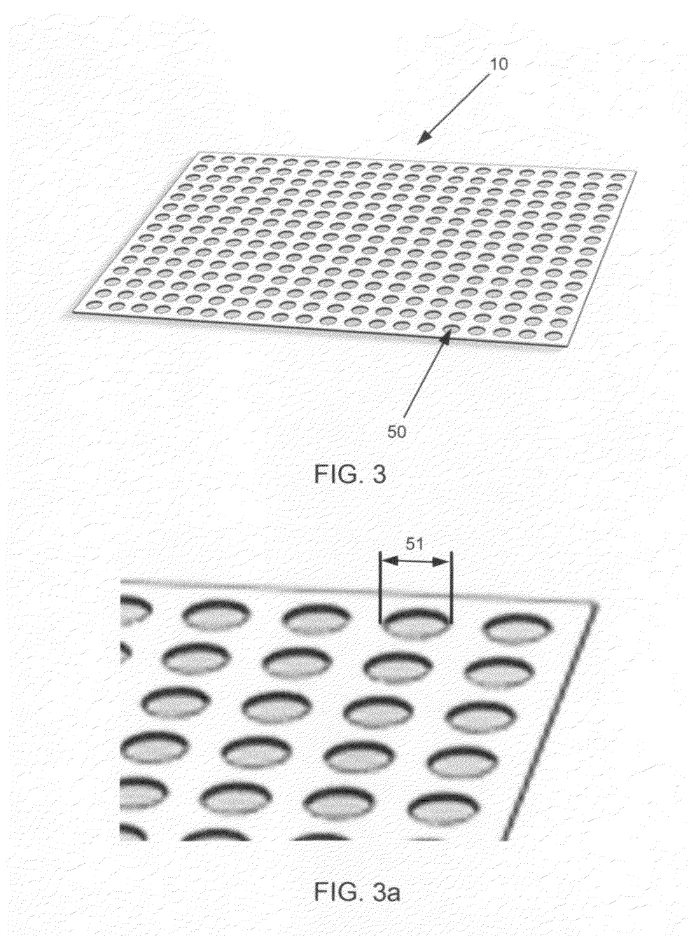

The perforations of the inventive plate and process greatly reduce the frequency at which fibrous material gets caught in the openings of a screen. As shown in FIG. 3 the perforated screen 10 has oval shaped perforations 50 with a span 51 (illustrated in the enlarged screen portion in FIG. 3a). The span 51 extends from one end of a perforation to the other end across the greatest length dimension of the perforation 50. The oval perforations do not catch fibrous materials at the rate of screens having holes with corners or overlaying wire. The perforated screen 10 can be constructed with small perforations having a span of less than 0.1 inch. In some embodiments the span is 1/32 inch or smaller. These small perforations can allow fluid to pass through while they can also ameliorate the issue of fibers blinding.

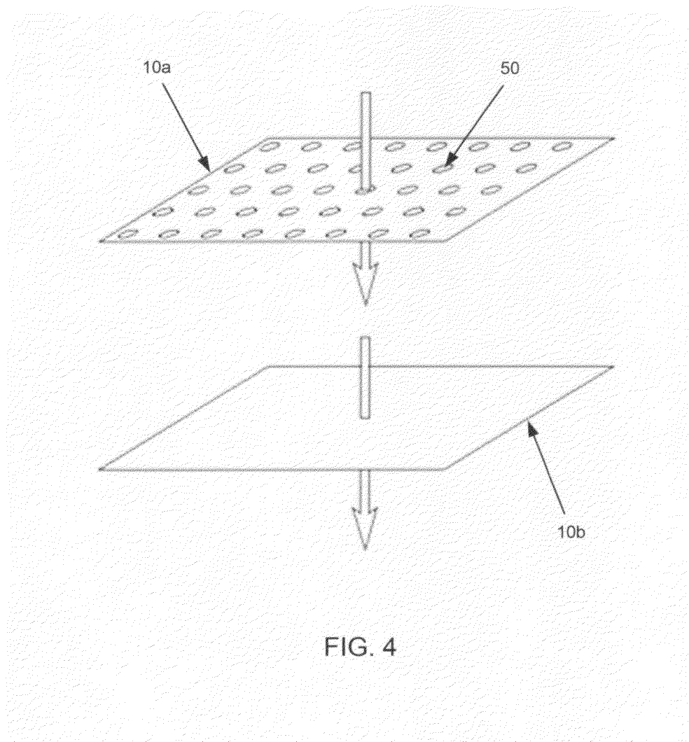

In some embodiments, as schematically shown in FIG. 4, separating the wet fibrous matter into fibrous material and fluid can be performed using at least one perforated plate/screen 10a and at least one non-perforated plate/screen 10b (e.g. standard wire mesh screen). When placed on a perforated plate 10a, the fibrous matter (wet or not) can be vibrated by vibration of the plate 10a such that the larger fibrous material remains on the upper surface of the perforated plate 10a until it is conveyed off of the perforated plate. Fine material and fluid can pass through perforations 50 of the perforated plate 10a and onto non-perforated plate 10b where blinding of the screen is not as likely because of the diminished amount or complete lack of fibrous material. The screens 10a and 10b within a vibrating shaker can separate the large fiber material from the fine material by collecting the fibrous material as it is conveyed by perforated plate/screen 10a and collecting the fine material as it is conveyed by non-perforated plate/screen 10b.

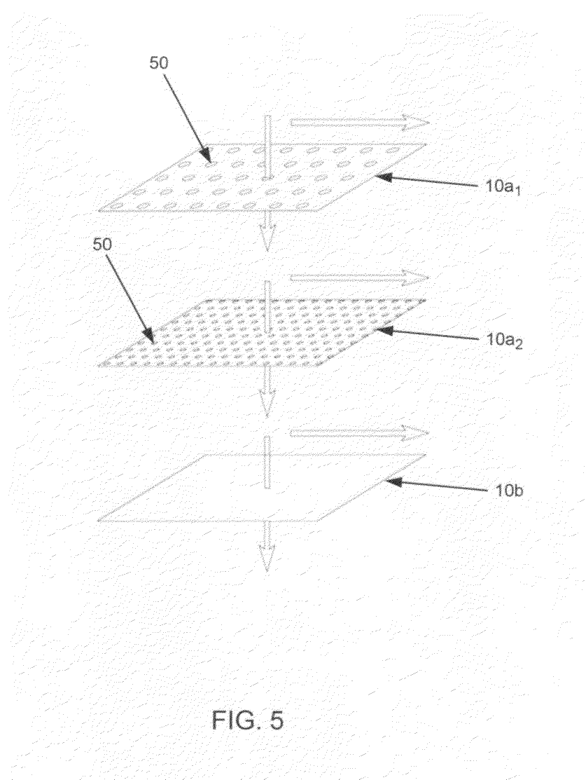

In FIG. 5 multiple perforated plates 10a₁ and 10a₂ with non-perforated plate 10b are shown. Here, perforated plate 10a₁ has larger perforations 50 than does perforated plate 10a₂. Fibrous matter disposed on perforated plate 10a₁ can allow fluid, fine material and some smaller fibers through the larger perforations 50 of perforated plate 10a₁, but without the same blinding issue as the perforations have a diminished rate in fibers being caught within the perforations 50.

Plate 10a₂ can then allow the fluid and fine material to pass through its perforations 50 and transfer onto non-perforated plate 10b. On the non-perforated plate 10b there is further separation as the fines do not pass through the holes of the non-perforated plate while the fluid does. The vibratory action on each of the screens 10 of FIG. 5 can convey the separated material into separate areas for collection.

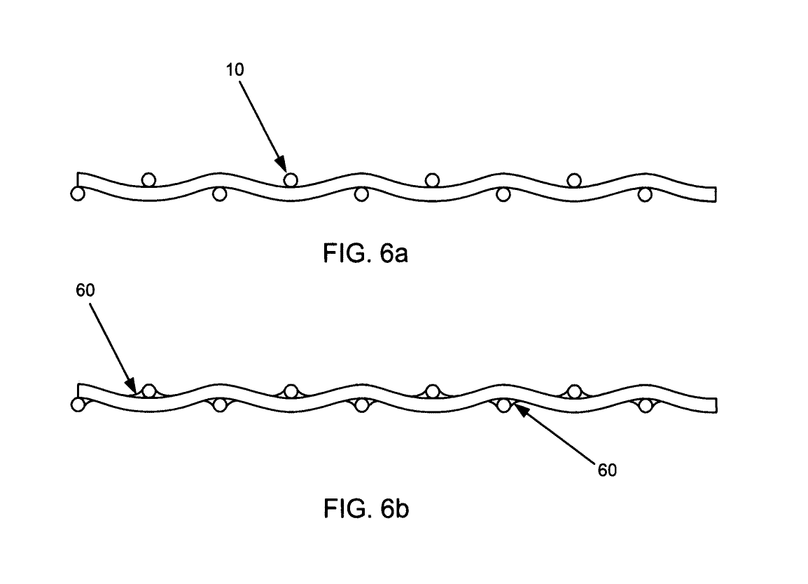

Another embodiment of the invention includes a screen 10 wherein the perforations 50 are formed through a coating 60 covering the initial holes in a wire screen mesh. This is shown in FIGS. 6a and 6b. FIG. 6a is a side view of a non-perforated wire screen mesh 10. As shown in FIGS. 1 and 2 these screen mesh screens can have corners 40 that tend to catch fibrous material. By coating at least the holes 30 of a non-perforated plate 10 (e.g. woven screen or wedge wire screen) such that the holes 30 are filled in, a perforated plate (as shown in FIG. 6b) can be manufactured by forming perforations 50 through the coating 60 covering the holes 30. These perforations 50 can be made by punching holes out with a press or with fluid or gas pressure; grinding holes; cutting holes through by use of a saw, laser, liquid, or gas; chemically creating the holes, or any combination of these. In this manner the coating 60 can eliminate sites such as corners or where two portions of the screen 10 are fabricated together. In FIG. 6b the coating 60 has perforations created by having material removed or relocated such that a perforated plate is formed. These perforations 50 can in some embodiments be made very small (e.g. smaller than the original holes of the original woven screens). One method for manufacturing this perforated screen is using a paint as a coating 60 and before the paint or epoxy coating dries blowing air through the screen 10 such that excess coating is removed from the center of the holes 30/50 but remains where the original corners 40 were such that the corners 40 are covered with the coating 60 and tend to catch less fibrous material than when uncovered.

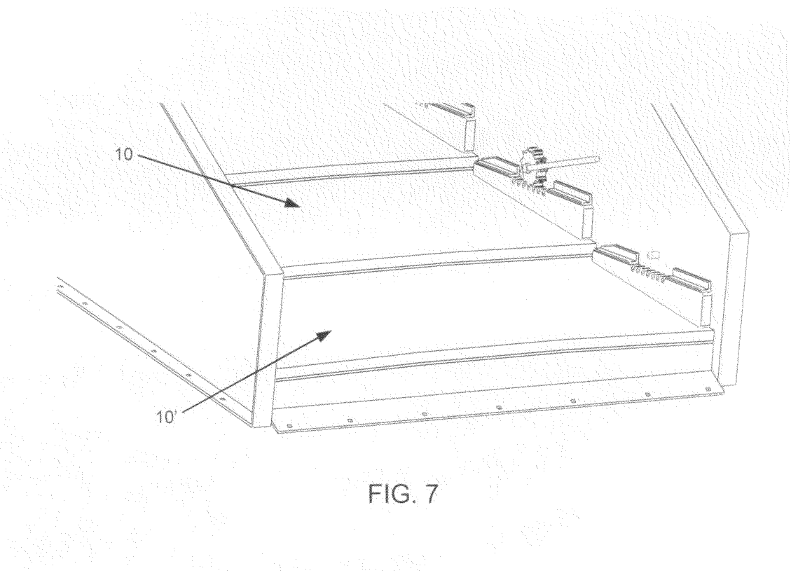

While the screens/plates 10 as illustrated in FIGS. 4 and 5 show the screens/plates disposed directly above/beneath the other screen/plate(s) 10, in some embodiments the screens 10 are arranged in a sequential and/or stepped configuration as shown in FIG. 7. In FIG. 7 the screens/plates 10 are disposed within a vibrating screen device 70. Here, the fibrous matter can have fluid and/or fine materials pass through each screen. The fibrous material is conveyed along each screen/plate 10 and transfers to the next lower screen/plate 10 until it transfers off the vibrating screen device 70. In some embodiments the perforated plates, instead of being stepped down are simply butted up against each other such that the material is conveyed from one screen surface to an adjacent screen surface. In some embodiments the vibrating screen device 70 has a vibratory motion that is oval shaped. In some embodiments the vibrating screen device 70 has a vibratory motion that is elliptical. In some embodiments the vibrating screen device 70 has a vibratory motion of about 1800 cycles per minute. In some embodiments the vibrating motion is linear. In some embodiments a vibratory motion of between about 500-1200 cycles per minute can be used. In some embodiments a vibratory motion of between about 1200-1800 cycles per minute can be used. In other embodiments a vibratory motion of between about 1800-3600 cycles per minute can be used. Vibratory motion of less than 500 or more than 3600 cycles per minute can also be used in some embodiments.

In some embodiments, the fibrous material can be conveyed along each screen in paths that are substantially straight. In some embodiments that paths are substantially parallel to one another. Thus, regardless of where each portion of fibrous material is put or transferred onto a particular screen, each portion can move in the substantially same direction. It is understood that solids conveyance requires that the solids leave the surface of the perforated plate, resulting in the solids falling back at a different location on the perforated plate to be carried forward by the perforated plate. In fact the screen vibration can result in oval shaped motions of the fibrous material when the material rises from the screen. Within this application, such movement is consistent with the terms “substantially straight” and “substantially parallel” as the material is moving generally in a straight and/or parallel path when viewed looking straight down (top view) at the screen surface. When viewing the conveyance from a side view oval shaped movement (sometimes specifically elliptical motion) may be observed. It should be noted that there will be instances in which even from the top view the material can on occasion move in a non-linear and/or non-straight manner, but when the motion is described as substantially straight the movement is generally straight. Thus, in some embodiments the fibrous material is put on the proximal end of a screen and conveyed off the distal end of the screen while deviating no more than 2 inches from a straight line path from the proximal end to the distal end and perpendicular to the edges of both the proximal and distal ends.

In some embodiments, the movement of the material is in a zig-zag path from the proximal end to the distal end. In some embodiments movement of the fibrous material follows a single or multiple curved path.

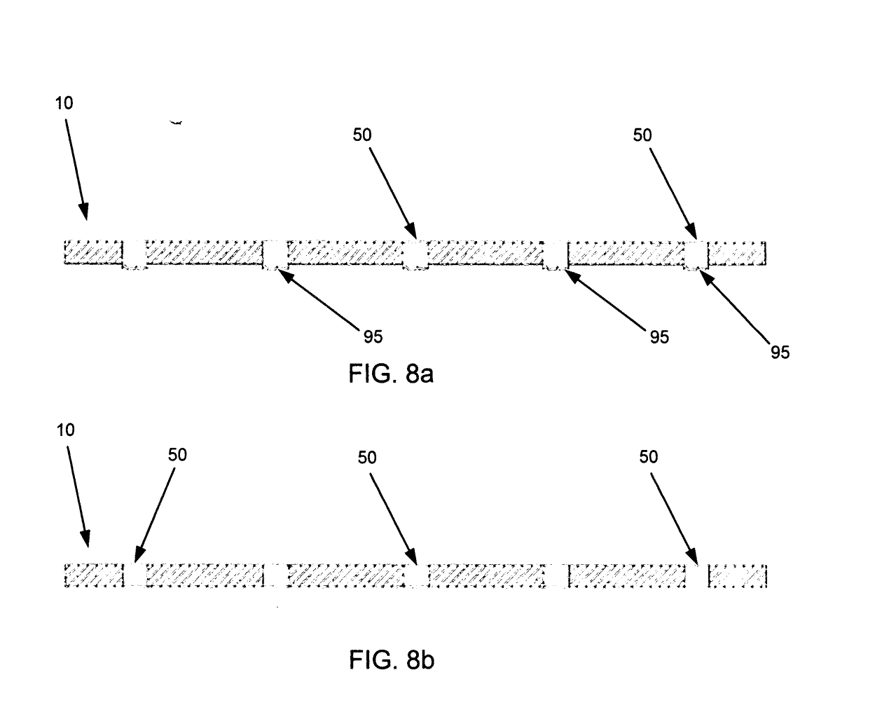

In some embodiments the perforated screen 10 has a bottom side wherein portions of the screen disposed about or adjacent to each perforation extend from the screen creating a crown 95 having sharp edges as shown in the cross-sectional side view of FIG. 8a. The crown 95 can tend to catch fibrous material that begin to pass through the perforations 50 of the perforated screen 10. By removing the crowns 95, fibrous material is less likely to be caught. Rounded edges on the underside of the screen would also be an improvement. These rounded edges would not tend to catch fibers. One method of fabricating an uncrowned perforated plate, which is a perforated plate with either rounded or absent crowns 95, is through scotch brighting the surface. Also, by vibrating an abrasive slurry with abrasives that are small and round but too large to pass through the perforation 50 or get stuck in the perforation 50, the crown 95 can be rounded or removed (as shown in FIG. 8b).

In some embodiments, spray nozzles can be used above the screen to break up clumps of material to be separated. This can also be desirable to help keep the product moving over the surface of the screen 10.

In some embodiments, spray nozzles can be used under the screen 10 to clear any fibrous material that gets caught on the underside of the screen 10. For example, one or more nozzles could be affixed to the vibratory screen device shown in FIG. 7 above one or more screens and/or positioned below one or more screens. The nozzle(s) could be placed on the wall of the vibratory screen device below and/or under the screen. Additionally, one or more nozzles could be positioned on a track set above and/or below the screen. This arrangement can allow the nozzle(s) to be moved on the track to be positioned and/or repositioned. The track can run from a proximal side of the screen(s) to a distal side. The track can also run across the width of the screen. It should be noted that a vibratory screen device having a single screen can also have nozzles placed as described above. An underside spray wash can dislodge materials, fibrous and non-fibrous (such as sand) which may be sitting in the opening, back onto the upper side of the perforated plate. Such a spray wash can also clear grease and other contaminates which may coat the opening. Materials such as wet toilet paper tend to stick to surfaces.

In some embodiments wet or non-wet non-fibrous material can be separated using a vibratory shaker having perforated plates with perforations no larger than 1/16 inch.

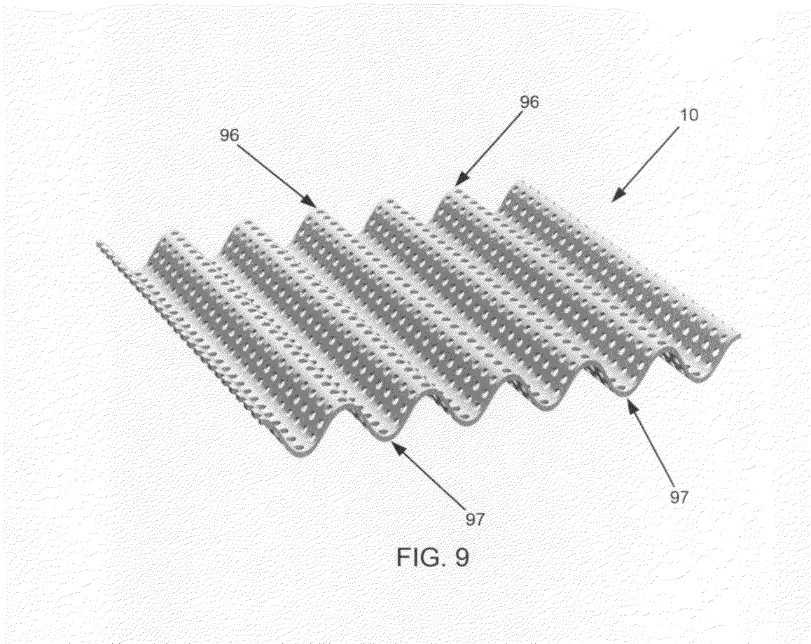

As shown in FIG. 9, the perforated plate does not need to be flat. There can be a single or multiple raised portion(s). In fact the plate/screen 10 can have a corrugated or sinusoidal shape with peaks 96 and valleys 97. The screen 10 can also include a mixture of flat and non-flat portions; examples of the flat portions are shown in FIGS. 1-8 and an example of the non-flat portions is shown in FIG. 9.

In some embodiments multiple sequential screens are used (see FIG. 7). It is often desirable to initially remove excess liquid with fine perforated screens which separate the fine fibrous materials from the liquid. These fibrous materials can mat together as excess liquid is removed. To further dry the matted materials a coarser perforated plate can be used. The fine fibrous materials remain on the larger mesh screen because they are caught in the matted material. Thus, in some embodiments, once the majority of the fluid is gone the mats of solids constrain each other, effectively agglomerating into larger solids which will not go thru larger holes.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A process of separating a fluid and fibrous material from wet fibrous matter by:
putting the wet fibrous matter onto a vibrating screen device, the vibrating screen device having a plurality of screens in a sequential configuration, each of the plurality of screens having a perforated center portion with oval shaped perforations, the perforations having a span of no greater than 0.1 inches,
vibrating each screen to expedite separation of the fibrous material and the fluid from the wet fibrous matter on each screen such that the fluid separated from the wet fibrous matter on each screen passes through the perforations and the fibrous material conveys along the screen,
conveying the fibrous material from a screen that is sequentially before to a screen that is sequentially after for further separating the fluid from the fibrous material.

2. The process of claim 1 wherein the fibrous matter is selected from the group consisting of biological matter, petroleum based matter, geologic matter, and any combination thereof.

3. The process of claim 1 wherein at least one of the screens has perforations having a span of no greater than 1/32 inches.

4. The process of claim 1 wherein the sequential configuration is a stepped down configuration.

5. The process of claim 1 having a woven screen which has been coated with a coating material selected from the group consisting of paint, plastics, epoxies, and any combination thereof and where the perforations are formed through the coating material.

6. The process of claim 1 including spraying at least one of the screens to dislodge any material caught in the pores, the spraying being from a location selected from the group consisting of above the screen, below the screen, and above and below the screen.

7. The process of claim 1 wherein the sequential configuration includes screens that are adjacent to one another such that one end of a sequentially after screen is butted against a sequentially before screen.

8. A process of separating a fluid and fibrous material from wet fibrous matter by:
putting the wet fibrous matter onto a screen having a perforated center portion, the screen disposed in a vibratory screen device and having perforations of no greater than 0.1 inches, vibrating the screen to expedite separation of the fibrous material and the fluid from the wet fibrous matter such that the fluid passes through the perforations and the fibrous material conveys along the screen in a substantially straight line.

9. The process of claim 8 wherein the screen has perforations having a span of no greater than 1/32 inches.

10. The process of claim 8 wherein the fibrous matter is selected from the group consisting of biological matter, petroleum based matter, geologic matter, and any combination thereof.

11. The process of claim 8 wherein the screen is constructed of materials selected from the group consisting of metals, plastics, ceramics, and any combination thereof.

12. The process of claim 8 wherein the screen is coated with a coating material through which perforations are formed, the coating material selected from the group consisting of paint, plastics, epoxies, and any combination thereof.

13. The process of claim 8 wherein the vibrating screen device includes a plurality of screens.

14. The process of claim 13 wherein the plurality of screens are arranged in a stepped down configuration such that the fibrous material conveyed off any upper screen is passed to a lower screen.

15. The process of claim 13 where in the plurality of screens are arranged adjacent to one another such that one end of a sequentially after screen is butted against a sequentially before screen.

16. The process of claim 13 wherein the fluid is selected from the group consisting of water based fluid, oil based fluid, gelatinous based fluid, plasma based fluid, and any combination thereof.

17. The process of claim 13 wherein the vibrating screen device includes at least one perforated screen and at least one non-perforated screen.

18. The process of claim 8 wherein the fibrous material is conveyed along the screen in paths that are substantially parallel.

19. The process of claim 8 wherein the screen is corrugated.

20. The process of claim 8 wherein the perforated plate is an uncrowned perforated plate.

21. The process of claim 8 including spraying a fluid on the perforated plate for improving conveyance of the fibrous material, at least one spray nozzle being disposed on the vibratory screen device and directed toward the perforated plate, the at least one spray nozzle being disposed in a location selected from the groups consisting of above the perforated plate, below the perforated plate, and above and below the perforated plate.

22. A process of separating a fluid and solid material from wet solid matter by:
putting the wet solid matter onto a vibrating screen device, the vibrating screen device having a plurality of screens in a sequential configuration, each of the plurality of screens having a perforated center portion with elliptically shaped perforations, the perforations having a span of no greater than 1/16 inches,
vibrating each screen to expedite separation of the solid material and the fluid from the wet solid matter on each screen such that the fluid separated from the wet solid matter on each screen passes through the perforations and the solid material conveys along the screen,
conveying the fibrous material from a screen that is sequentially before to a screen that is sequentially after for further separating the fluid from the fibrous material.
